(19) United States
(12) Patent Application Publication
(10) Pub. No.: US 2015/0009266 A1
(43) Pub. Date: Jan. 8, 2015

(54) INK CARTRIDGE AND INK JET PRINTER

(71) Applicant: SEIKO EPSON CORPORATION, Tokyo (JP)

(72) Inventors: Keiichi NOTO, Shiojiri-shi (JP); Mitsuhiro ISOBE, Kofu-shi (JP)

(21) Appl. No.: 14/323,976

(22) Filed: Jul. 3, 2014

(30) Foreign Application Priority Data
Jul. 4, 2013 (JP) 2013-140427

(51) Int. Cl. B41J 2/175

(52) U.S. Cl. CPC B41J 2/17503
USPC 347/86

(57) ABSTRACT

Provided is an ink cartridge in which ink is received and which includes a through-hole.

### CROSS-REFERENCE TO RELATED APPLICATIONS

This application claims priority to Japanese Patent Application No. 2013-140427 filed on Jul. 4, 2013. The entire disclosure of Japanese Patent Application No. 2013-140427 is hereby incorporated herein by reference.

### BACKGROUND

1. Technical Field

The present invention relates to an ink cartridge and an ink jet printer to which the ink cartridge is mounted.

2. Related Art

An ink jet recording apparatus which records an image on a recording medium using an ink jet recording head that can discharge ink supplied from an ink tank and which includes a recovery processing unit that performs a recovery process for maintaining a favorable ink-discharging state of the recording head, an ambient temperature detecting unit that detects an ambient temperature of the ink jet recording apparatus, and a controller that is held in an information holding unit of the ink tank and controls the recovery process on the basis of physical property information of the ink, which is in accordance with the detected ambient temperature, has been known (see JP-A-2006-159578).

Before an ink cartridge which is a container for receiving ink (it is also referred to as inkt, hereinafter collectively referred to as ink) which is supplied to the ink jet printer is mounted to an ink jet printer, the ink cartridge is usually stored in a location separate from an installation location (for example, an indoor place in which the ink jet printer is installed) of the ink jet printer. Therefore, in some cases, a temperature of an installation location of the ink jet printer is different from a temperature of the ink in the ink cartridge which is mounted to the ink jet printer. Accordingly, when, as similarly to a case of the disclosure described above, an ink temperature is indirectly acquired by, for example, measuring an ambient temperature and the recovery process is executed in accordance with the acquired ink temperature, a difference between an actual ink temperature and the acquired temperature is great. Accordingly, it is difficult to say that the optimum recovery process is executed.

The difference between the temperature of the installation location of the ink jet printer and the ink temperature increases with an increase in the size of the ink jet printer. The size of the ink cartridge increases with an increase of the size of the ink jet printer. However, a mass of the entire system of the ink cartridge having the increased size is large, and thus a heat capacity thereof is large. Accordingly, it is difficult to change the temperature of the ink cartridge. Thus, when the ink cartridge is mounted to the ink jet printer, it takes quite a long time until the temperature of the ink in the ink cartridge becomes equal to the temperature of the installation location of the ink jet printer. Therefore, in this case, it is necessary for a user to wait to use the ink jet printer until the ink temperature becomes equal to the temperature of the installation location of the ink jet printer. As a result, a temporal loss of a user is significant.

In order to meet the safety requirements, it is necessary for an ink cartridge in which ink containing organic solvent is received to be stored in a well-ventilated outdoor place. Thus, the difference in temperatures between the installation location of the ink jet printer and the ink is particularly large in a cold area or in a winter season.

### SUMMARY

An advantage of some aspects of the invention is to provide an ink cartridge in which a temperature of ink can become closer to an ambient temperature within a short time and an ink jet printer to which the ink cartridge is mounted.

According to an aspect of the invention, there is provided an ink cartridge in which ink is received and which includes a through-hole.

In this case, the ink cartridge has the through-hole, and thus a contact area between the ink cartridge and the outside air increases. Accordingly, a temperature of the ink in the ink cartridge can become closer to an ambient (outside air) temperature within a short time.

The technical concept of the invention may be realized by a member other than the ink cartridge. For example, an apparatus (an ink jet printer) including the ink cartridge can be considered an example of the invention.

It is preferable that the ink jet printer further include a fan that blows air into the through-hole.

In this case, air is blown into the through-hole by operating the fan, and thus the temperature of the ink in the ink cartridge can become closer to the ambient temperature within a short time.

It is preferable that the ink jet printer further include a temperature sensor which is inserted in the through-hole.

In this case, the temperature is measured by the temperature sensor which is inserted in the through-hole of the ink cartridge, and thus it is possible to detect the ink temperature with high accuracy. In addition, a configuration which includes the ink cartridge and the temperature sensor can achieve a very compact size.

It is preferable that the ink jet printer further include a carriage which can move in a predetermined direction in a state where the ink cartridge is mounted thereon, in which the through-hole passes through the ink cartridge in the predetermined direction.

In this case, air passes through the through-hole with movement of the carriage, and thus the temperature of the ink in the ink cartridge can become closer to the ambient temperature with in a short time. Furthermore, the through-hole is provided, and thus turbulence of air flow, which is caused when the carriage moves, is prevented from occurring. Accordingly, so-called floating up of ink mist (that is, part of the ink ejected from the recording head, which floats in mist form without landing on a print substrate) can be reduced.

In this specification, the “ink cartridge” can also be referred to as an “ink tank” or a “liquid receiving container”. In addition, the ink jet printer according to the invention includes both a printer in which an ink cartridge is mounted on a carriage, and a printer in which an ink cartridge is not mounted on a carriage. Furthermore, the ink jet printer includes both a printer having a carriage and a printer not having a carriage.

### BRIEF DESCRIPTION OF THE DRAWINGS

The invention will be described with reference to the accompanying drawings, wherein like numbers reference like elements.

FIG. 1 is a perspective view of a printer.

FIG. 2 is a cross-sectional view illustrating a schematic configuration of the printer.

FIG. 3 is a perspective view of an ink cartridge.

FIG. 4 is a view illustrating a configuration in the vicinity of an ink cartridge according to Modification Example 1.

FIG. 5 is a perspective view of an ink cartridge according to Modification Example 2.

FIG. 6 is a cross-sectional view of an ink cartridge according to Modification Example 3.

FIG. 7 is a view illustrating a configuration in the vicinity of an ink cartridge according to Modification Example 4.

### DESCRIPTION OF EXEMPLARY EMBODIMENTS

Hereinafter, an embodiment of the invention will be described with reference to the accompanying drawings.

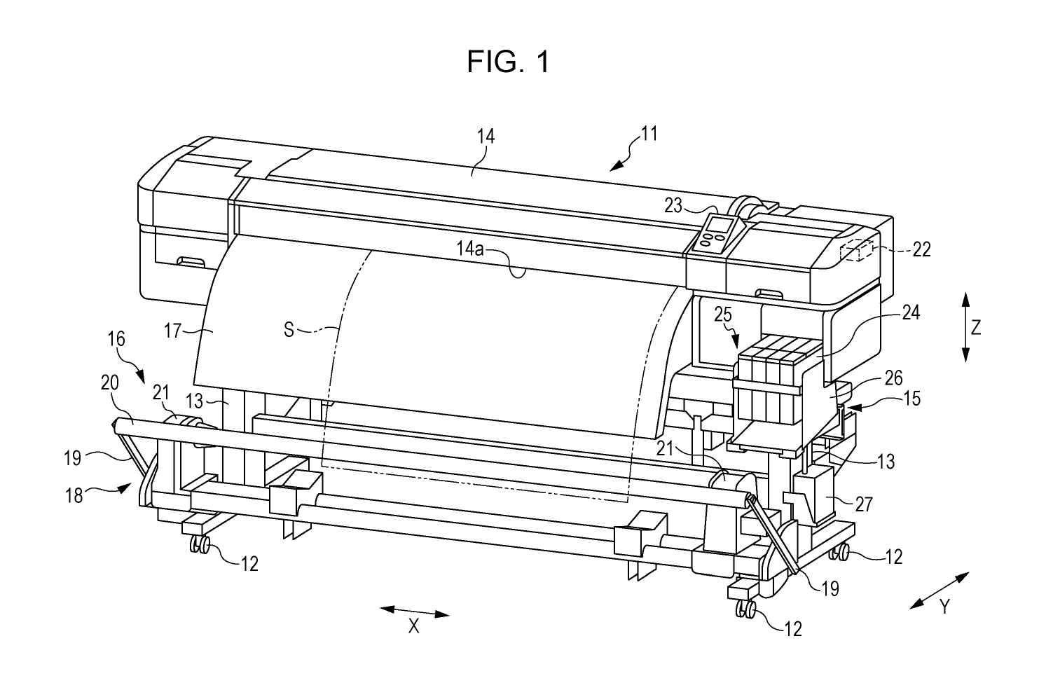

FIG. 1 illustrates an example of a printer 11 according to the embodiment. A printer is an output device which makes a hard-copy record of data, in which rows of discrete images and letters, which belong to one or a plurality of predetermined letter groups are used as a main style (JIS X0012-1990). In many cases, a printer can also be used as a plotter. A plotter is an output device which directly forms and outputs, on a removable medium, a hard-copy record of data with a two-dimensional image style (JIS X0012-1990). Any device can be used as the printer 11 as long as it functions as a printer, and the printer 11 may be a so-called multifunctional printer which functions as a scanner and a copying machine. In the embodiment, the printer 11 is an ink jet printer. The ink jet printer is a device which is a non-impact printer and which prints letters on a paper sheet by ejecting particles or small droplets of ink (JIS X0012-1990).

In an example illustrated in FIG. 1, the printer 11 is a large format printer (LFP) in which a long paper sheet S as an example of a print substrate is used. A print substrate is a material on which a printed image is held. Generally, a print substrate has a rectangular shape. However, a print substrate may have a circular shape (for example, an optical disk such as a CD-ROM, a DVD, and the like), a triangular shape, a rectangular shape, a polygonal shape, or the like. A print substrate includes at least all types of papers and boards disclosed in Japanese Industrial Standards “JIS P0001:1998 Paper, board and pulp” and processed products thereof. The printer 11 includes a pair of leg portions 13 having wheels 12 attached on lower ends thereof and a casing portion 14 which is installed on the leg portions 13. In the embodiment, a longitudinal direction of the casing portion 14, which intersects (in the embodiment, which is perpendicular to) an up/down direction Z parallel to the gravity direction is set to a width direction X. In addition, a direction which intersects (in the embodiment, which is perpendicular to) both the up/down direction Z and the width direction X is set to a front/rear direction Y.

A paper feeding portion 15 which feeds the paper sheet S to the casing portion 14 side is provided in a lower portion of a rear side of the casing portion 14. In addition, a winding portion 16 which is supported by the leg portion 13 is provided in a lower portion of a front side of the casing portion 14. Furthermore, a supporting member 17 is provided between a paper feeding portion 15 and the winding portion 16 to extend along a transporting path of the paper sheet S. A rear end side of the supporting member 17 is accommodated in the casing portion 14 and a front end side of the supporting member 17 protrudes from the casing portion 14 to a lower front side. In a front surface side of the casing portion 14, a discharging port 14a through which the paper sheet S is discharged from an inner portion of the casing portion 14 is formed in a position above the supporting member 17.

A tension applying mechanism 18 which applies tension to the paper sheet S located in a portion between the supporting member 17 and the winding portion 16 is provided in the vicinity of the winding portion 16. The tension applying mechanism 18 includes a pair of arm members 19 which are rotationally supported in lower portions of the leg portions 13 and a tension roller 20 which is rotatably supported in tip portions of a pair of arm members 19.

The winding portion 16 includes a pair of holders 21 which pinch, from both axial sides, a core member (which is not illustrated and is, for example, a paper tube) around which the printed paper sheet S is wound in a cylindrical shape. One (a right one in FIG. 1) of the holders 21 rotates, and thus the paper sheet S is wound around the core member which is mounted between the pair of holders 21. In other words, the winding portion 16 constitutes a transporting mechanism, and the holders 21 are located in a downstream end of the transporting path of the paper sheet S. Although the winding portion 16 of the embodiment is a spindleless type in which a spindle is not provided, the winding portion 16 may be a type equipped with a spindle.

A controller 22 which controls operations of the printer 11 on the basis of programs is provided in the casing portion 14. In an upper portion of the casing portion 14, an operation panel 23 with which a setting operation and an input operation are executed is provided on one end side (a right end side in FIG. 1) in the width direction X, which is outside of the transporting path of the paper sheet S. The operation panel 23 is electrically connected to the controller 22.

In a lower portion of the casing portion 14, an ink cartridge 24 in which ink as an example of liquid can be received is provided on the one end side (the right end side in FIG. 1) in the width direction X, which is outside the transporting path of the paper sheet S. A plurality (four in the embodiment) of the ink cartridges 24 are provided to correspond to types and colors of ink. A liquid receiving unit 25 is constituted by the plurality of ink cartridges 24 which are mounted to the casing portion 14 to be aligned in the width direction X. Each ink cartridge 24 and the entirety of the liquid receiving unit 25 can be attachable/detachable to/from the casing portion 14. The printer 11 includes a protection portion 26 which is provided to surround the liquid receiving unit 25 to protect the ink cartridge 24. The protection portion 26 is disposed such that a gap is provided between the ink cartridge 24 and the protection portion 26. A wasted liquid tank 27 is fixed to one (a right one in FIG. 1) of the leg portions 13.

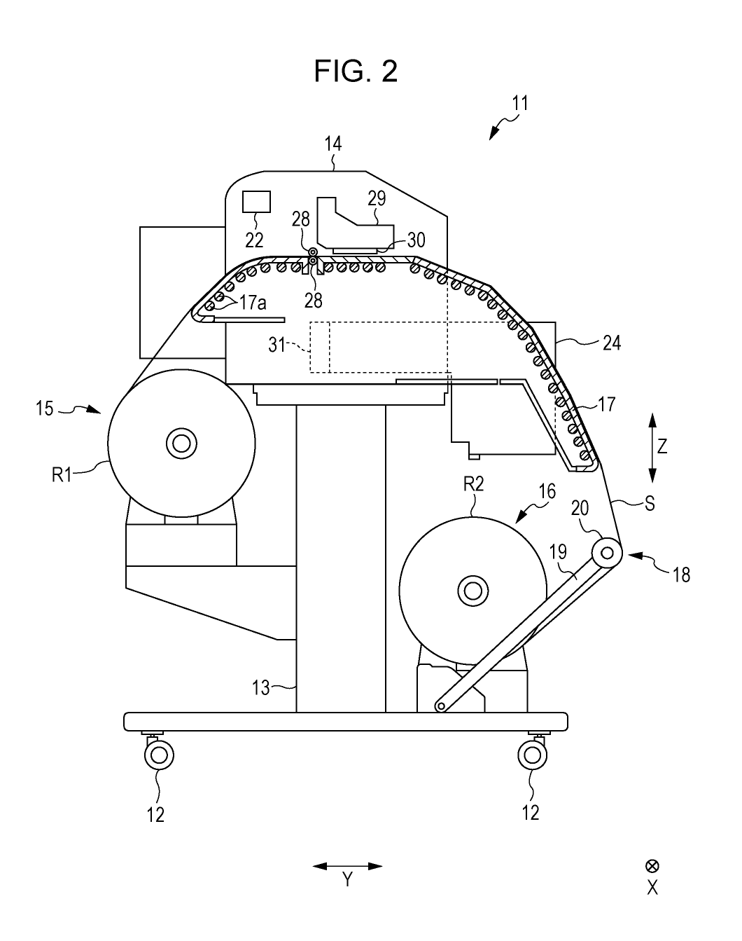

A roller body R1 around which an unused paper sheet S is wound in a cylindrical shape is held in the paper feeding portion 15, as illustrated in FIG. 2. A pair of transport rollers 28 which transport the paper sheet S that is fed from the paper feeding portion 15 and a carriage 29 which reciprocates in a main scanning direction (the width direction X, in the embodiment) perpendicular to the transporting direction of the paper sheet S are accommodated in the casing portion 14. The carriage 29 reciprocates along a carriage shaft (not illustrated). A liquid ejection portion 30 which can eject the ink through nozzles (not illustrated) is held in a lower portion of the carriage 29. The liquid ejection portion 30 can also be referred to as a “recording head”, a “printing head”, or the like.

An end portion of a base end side (a rear end side, in the embodiment) of the ink cartridge 24, which is accommodated in the casing portion 14, is connected to a liquid supplying mechanism 31 which supplies the ink to the liquid ejection portion 30. The liquid ejection portion 30 which reciprocates along with the carriage 29 ejects the ink which is supplied from the ink cartridge 24, and thus a recording operation (a printing operation) is performed on the paper sheet S which is transported along the transporting path. Heaters 17a which dry the ink landing on the paper sheet S are provided on a rear side of the supporting member 17. The printed paper sheet S is guided, obliquely downward, along the supporting member 17, and then the printer paper sheet S is wound by the winding portion 16. Accordingly, a rolled body R2 is formed.

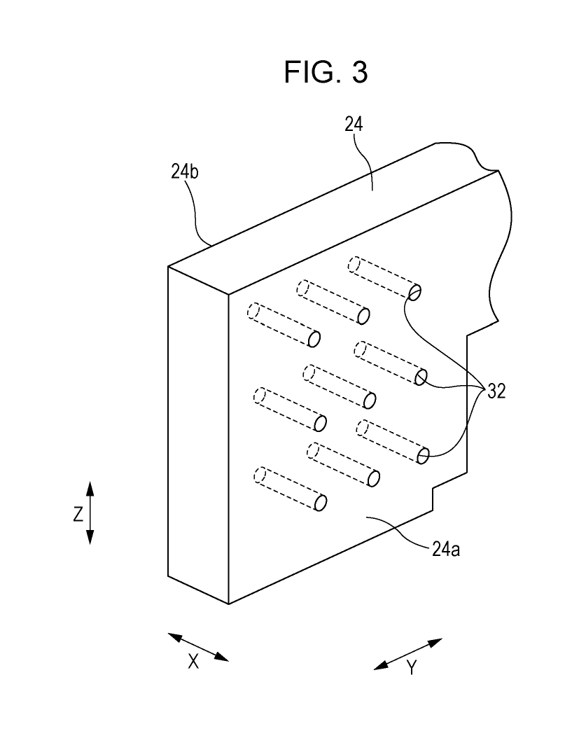

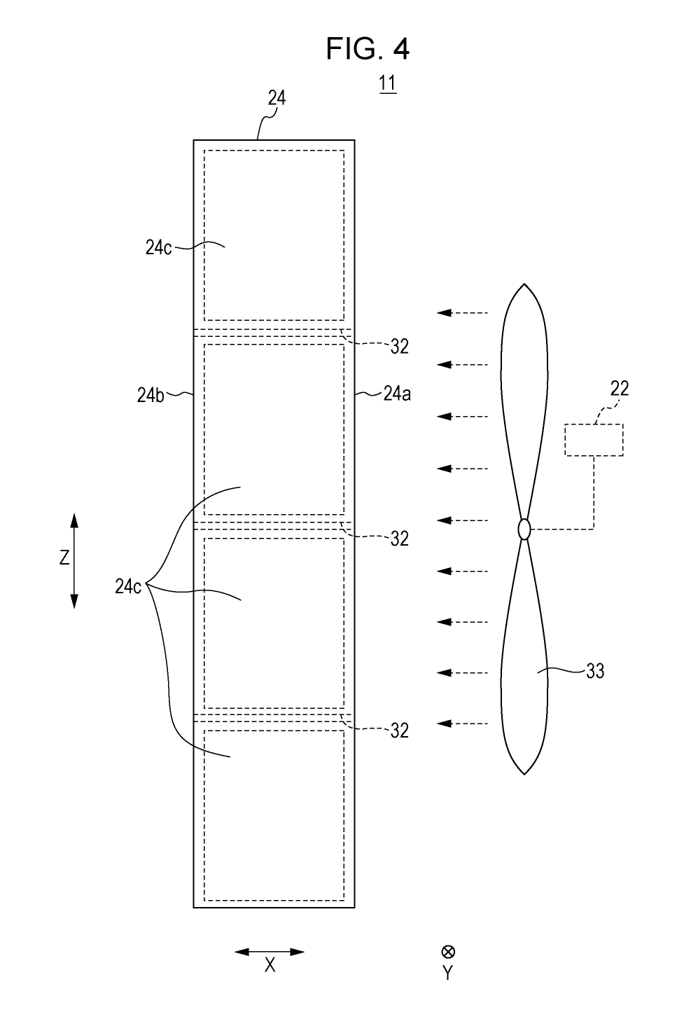

FIG. 3 is a perspective view illustrating the appearance of a part of an ink cartridge 24. For simple illustration, the shapes of some portions of the ink cartridge 24 are not identical to each other in FIGS. 1 to 3. The ink cartridge 24 has a plurality of through-holes 32, as illustrated in FIG. 3. The through-holes 32 are not illustrated in FIGS. 1 and 2. The through-hole 32 passes through the ink cartridge 24 from one surface 24a of the ink cartridge 24 to the other surface 24b opposite the one surface 24a. Although the cross-sectional surface (the cross-sectional surface perpendicular to a penetrating direction) of the through-hole 32 is circular in FIG. 3, the cross-sectional surface thereof may have various shapes, such as a polygonal shape, an elliptical shape, and the like. Furthermore, the size of the cross-sectional surface of the through-hole 32 and the number of the through-holes 32 are not particularly limited. FIG. 3 (and FIGS. 4 to 7 which are described below) illustrates a relationship between the direction of the ink cartridge 24 and the X, Y, and Z directions. However, this illustration is made on the assumption that the ink cartridge 24 is mounted to the printer 11, and thus, needless to say, the illustration does not make sense for the ink cartridge 24 in a state where the ink cartridge 24 is not mounted to the printer 11.

According to the embodiment, the ink cartridge 24 has the through-holes 32, and thus a contact area with the outside air increases. Thus, the temperature of the ink in the ink cartridge 24 can become closer to the ambient (outside air) temperature within a short time. Accordingly, in a case where there is a difference between the temperature of the printer 11 in an installation location and the temperature of the ink in the ink cartridge 24 when the ink cartridge 24 is mounted in the printer 11, it is possible to significantly reduce a temporal loss of a user described above. This invention is effective for various types of printers as long as it has an ink cartridge. However, in the various types of printers having ink cartridges, this invention is particularly effective for a printer, such as an LFP, of which the size of an ink cartridge has been increased. When an ink cartridge in which ink having organic solvent is stored is used or when an ink cartridge is used in a cold area or in a winter season, the difference in temperatures is particularly great. However, even in this case, it is possible to significantly reduce a temporal loss of a user.

Although only one ink cartridge 24 is illustrated in FIG. 3, other ink cartridges 24 mounted to the printer 11 also have the through-holes 32. The through-holes 32 are formed on each ink cartridge 24 such that, in a state where a plurality of the ink cartridges 24 are mounted to the printer 11, as illustrated in FIG. 1, the through-holes 32 of the adjacent ink cartridges 24 communicate in a predetermined direction. Accordingly, it is possible to say that the liquid receiving unit 25 has the through-holes 32 passing therethrough.

Hereinafter, a plurality of modification examples of the embodiment will be described.

### Modification Example 1

FIG. 4 illustrates a modification example when seen from a view point vertically separate from a predetermined surface which connects the surfaces 24a and 24b of the ink cartridge 24. In FIG. 4, ink receiving spaces 24c for receiving the ink and a plurality of the through-holes 32, which constitute an inner portion of the ink cartridge 24, are illustrated by the dot-dash line. In FIG. 4, the printer 11 has a fan 33 in the vicinity of the ink cartridge 24. The fan 33 is electrically connected to, for example, the controller 22 and an operation of the fan 33 is controlled by the controller 22. According to a configuration illustrated in FIG. 4, air is blown into the through-holes 32 by operating (rotating) the fan 33, and thus the temperature of the ink in the ink cartridge 24 can become closer to the ambient temperature within a short time. Although an installation position of the fan 33 is not limited, the fan 33 may be disposed in, for example, a gap between the liquid receiving unit 25 and the protection portion 26.

### Modification Example 2

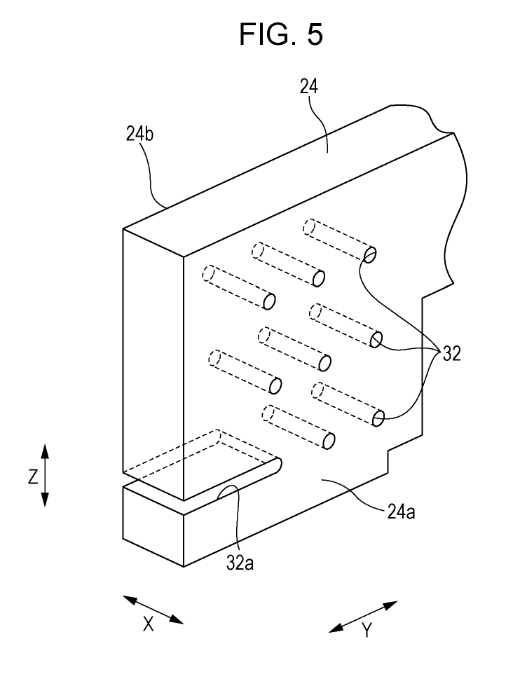

FIG. 5 illustrates a perspective view of a modification example of the ink cartridge 24, similarly to FIG. 3. The through-hole 32 of the ink cartridge 24 is not limited to a through-hole which is open in only two directions (the surface 24a side and the surface 24b side, in the examples in FIGS. 3 and 5), and the through-hole may be open in three directions, as indicated by the reference numeral and letter 32a in FIG. 5. A through-hole 32a is provided as illustrated in FIG. 5, and thus it is possible to increase a contact area between the ink cartridge 24 and the outside air.

Needless to say, the shape of the ink cartridge 24 is not limited to those illustrated in FIGS. 1 to 5. The shapes of ink cartridges can have various three-dimensional shapes, such as a plate shape, a cylindrical shape, a prismatic shape, and the like as long as ink can be received in the ink cartridges and the ink cartridges can be mounted to the printer 11. Regardless of the shape of the ink cartridge 24, the ink cartridge 24 of the embodiment has a through-hole which passes therethrough.

### Modification Example 3

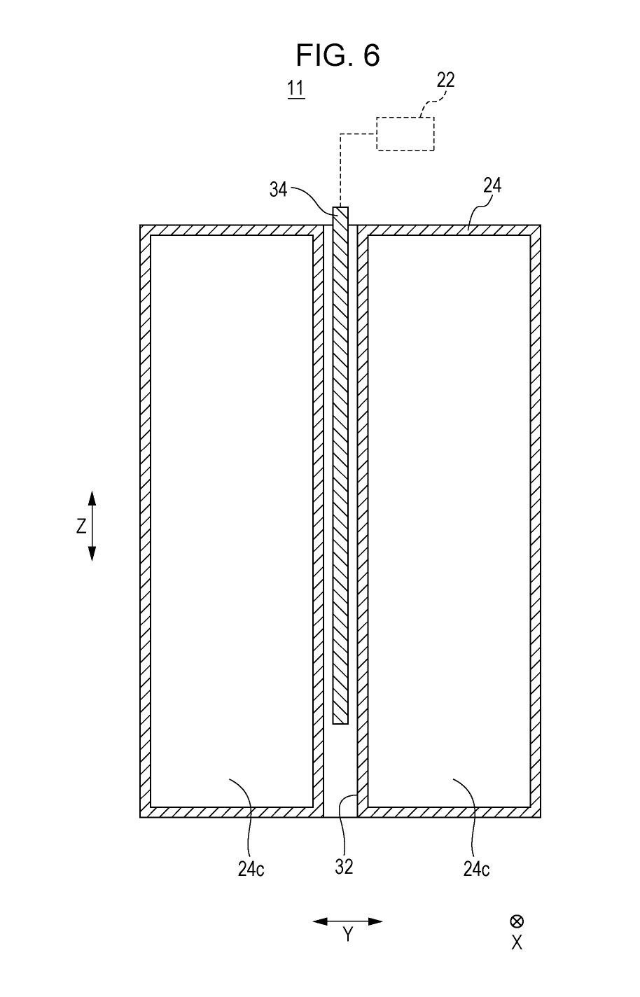

FIG. 6 illustrates a cross-sectional surface of a modification example of the ink cartridge 24, which includes the through-hole 32. For simple illustration, only one through-hole 32 is illustrated in FIG. 6. The shape of the ink cartridge 24 and a direction of the through-hole 32 illustrated in FIG. 6 are different from aspects illustrated in FIGS. 3 to 5. In an example in FIG. 6, the printer 11 has a temperature sensor 34 which is inserted in the through-hole 32 of the ink cartridge 24. The temperature sensor 34 is electrically connected to, for example, the controller 22 and a detection result of the temperature by the temperature sensor 34 is transmitted to the controller 22. According to this configuration, the temperature is measured by the temperature sensor 34 which is inserted in the through-hole 32, and thus it is possible to detect the ink temperature with high accuracy. As a result, this contributes to the accurate performance various control processes (such as a recovery process described above) in accordance with the ink temperature. Furthermore, the temperature sensor 34 is inserted in the through-hole 32, and thus this contributes to the miniaturization of the configuration which includes the ink cartridge 24 and the temperature sensor 34. Needless to say, the temperature sensor 34 may be inserted in at least some of the through-holes 32 illustrated in FIGS. 3 to 5.

### Modification Example 4

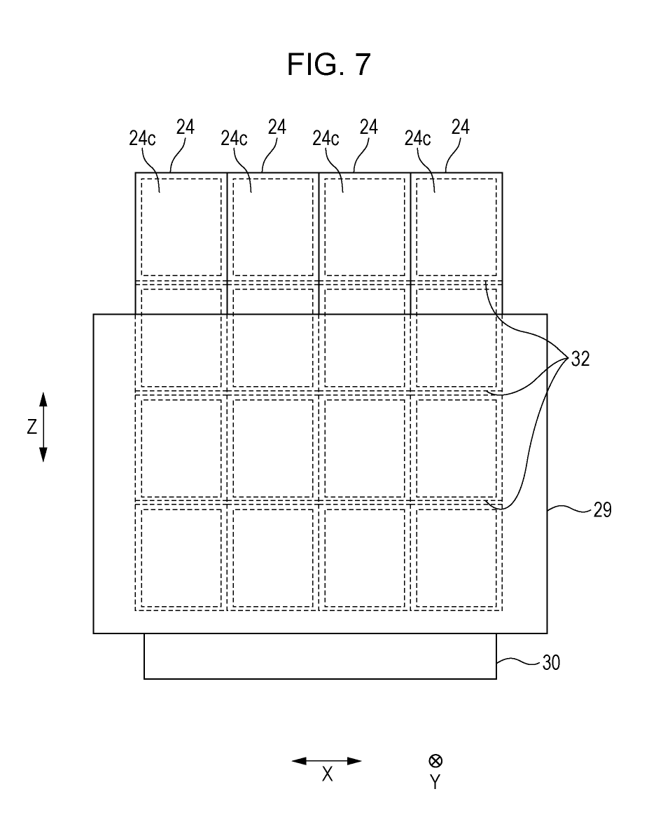

FIG. 7 illustrates a modification example in which the ink cartridge 24 is mounted on the carriage 29. The printer 11 in an aspect in which the ink cartridge 24 is mounted on the carriage 29 is usually applied not to an LFP type but to a printer type in which printing is performed on the paper sheet S having, for example, a substantially A4 size. In an example in FIG. 7, four ink cartridges 24 are mounted on the carriage 29. The carriage 29 can reciprocate in the main scanning direction (the direction X), as described above. In a state where the ink cartridge 24 is mounted on the carriage 29, the through-hole 32 passes through the ink cartridge 24 in the main scanning direction. According to this configuration, air passes through the through-hole 32 with the movement of the carriage 29, and thus the temperature of the ink in the ink cartridge 24 can become closer to the ambient temperature within a short time. Furthermore, the through-hole 32 is provided, and thus turbulence of air flow, which is caused when the carriage 29 moves, is prevented from occurring. Accordingly, so-called floating up of ink mist is reduced, and thus it is easy to obtain a high-quality printing result having fewer stains.

### Modification Example 5

As a modification example, the printer 11 may be a so-called line type ink jet printer which does not include the carriage 29. In a case of a line type ink jet printer, the liquid ejection portion 30 which receives the ink supply from the ink cartridge 24 is configured to extend in the direction X such that a plurality of nozzles are aligned along a length which corresponds to a width of the paper sheet S. Such a liquid ejection portion 30 having a long shape can be referred to as a “head for a line printer”.

The invention also includes configurations in which some or all of the respective modification examples described above are combined. However, the configuration in FIG. 7 cannot be applied to the configuration of a line type ink jet printer.

What is claimed is:

1. An ink cartridge in which ink is received, comprising:
a through-hole.

2. An ink jet printer comprising:
the ink cartridge according to claim 1.

3. The ink jet printer according to claim 2, further comprising:
a fan which blows air into the through-hole.

4. The ink jet printer according to claim 2, further comprising:
a temperature sensor which is inserted in the through-hole.

5. The ink jet printer according to claim 2, further comprising:
a carriage which can move in a predetermined direction in a state where the ink cartridge is mounted thereon,
wherein the through-hole passes through the ink cartridge in the predetermined direction.
